(19) United States
(12) Patent Application Publication
(10) Pub. No.: US 2008/0242154 A1
(43) Pub. Date: Oct. 2, 2008

(54) Powered, Mobile Electronics Mount

(76) Inventors: Steven C. Dixon, Lincoln Park, NJ (US); Harald Richter, Plorzhelm-Buchenbronn (DE)

Correspondence Address: Thomas & Raring, P.C., 536 GRANITE AVENUE, RICHMOND, VA, 23226, US

(21) Appl. No.: 11/692,354

(22) Filed: Mar. 28, 2007

(51) Int. Cl. H01R 31/00

(52) U.S. Cl. 439/638; 439/34; 439/447

(57) ABSTRACT

A powered, mobile electronics mount system has a male plug, a support arm, a connector housing, and an interconnecting wire. The male plug includes an electrical connector, wherein the plug is adapted to be inserted into an automobile electrical socket. The support arm is connected on one end to the male plug and on its opposite end to the connector housing, the connector housing having a transformer and a universal electrical connector socket, and the connector housing further including a mount for an electronics product. The interconnecting wire is in electrical connection with the automobile electrical socket through the plug and the universal electrical connector in the connector housing.

The present invention relates to mounts used in automobiles for supporting mobile electronics products. The mount includes an integral power connection that is adapted to deliver power from an automobile power socket to the electronics product and still provide a substantial support for the electronics product.

### BACKGROUND

At present, there are a wide variety of power connectors used with electronics products in automobiles. These connectors are typically plugged into the automobile power socket. A wire is typically connected to the plug and leads to a device specific adaptor that is inserted into and powers/recharges the electronics product. These products may typically include, but are not limited to, mobile phones, personal digital assistants, computers, GPS location devices, music players, etc.

Also at present, numerous vehicle mounts are known and used. These mounts are anchored into an automobile by suction, on vent screens, screws into the automobile frame, and mounts in the power outlet socket. The mounts may include swivel supports and/or also longer support arms referred to as goosenecks. The goosenecks typically include a rod or group of wires for flexible support. There may or may not be a plastic sleeve or other coating around the support rod.

More recently, with the explosion in the number of electronics products available for use in automobiles, problems can arise when a consumer is using or otherwise needs electrical power for multiple products at the same time. There is a limitation with respect to the single power/charger socket in a vehicle. While dual charger adaptors are available, they are typically made up of a plug and wire array that can result in a wire spaghetti mess and confusion.

### SUMMARY

Accordingly, it is an object of the present invention to overcome the foregoing drawbacks and provide a combination mount and charger device.

In one example, a powered, mobile electronics mount system includes a male plug, a support arm, a connector housing, and an interconnecting wire. The male plug includes an electrical connector, wherein the plug is adapted to be inserted into an automobile electrical socket. The support arm is connected on one end to the male plug and on its opposite end to the connector housing. The connector housing includes a transformer and a universal electrical connector socket, and the connector housing further includes a mount for an electronics product. The interconnecting wire is an electrical connection with the automobile electrical socket through the plug and the universal electrical connector in the connector housing. The connector housing may include a plurality of universal electrical connectors. The voltage input at the automobile electrical socket may be 12 to 24 volts. The voltage output at the universal electrical connector socket may be 5 volts or variations thereof. The universal electrical connector socket may be a USB socket. The plurality of universal electrical connector sockets may be different connection sockets. The mount on the connector housing can be selectively removable from the connector housing. The connector housing may comprise male mating elements adapted to receive a plurality of different, interchangeable mounts. The support arm may include a sleeve, and the interconnecting wire is positioned inside the sleeve.

### BRIEF DESCRIPTION OF THE DRAWINGS

FIG. 1 is a perspective view of a powered, mobile electronics mount system in accordance with an example of the present invention.

FIG. 2 is an exploded, perspective view of a mount and connector housing FIG. 3 is a perspective view of a mount and connecting housing.

FIG. 4 is a bottom view of a mount positioned on a connector housing.

FIG. 5 is an electrical diagram illustrating how the mount system provides power to a plurality of mobile electronics devices.

### DETAILED DESCRIPTION

The present invention is directed to a mount that also serves as an electrical connector for powering/recharging the product positioned on the mount. In one example, the mount has a plurality of connectors to power/recharge a plurality of electrical products. Although one example is shown herein, those of skill in the art can design similar mount configurations using the teachings herein.

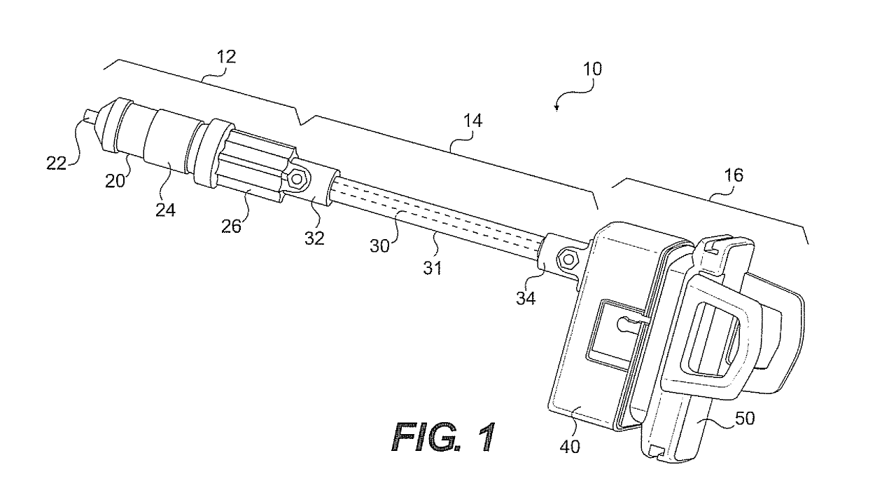

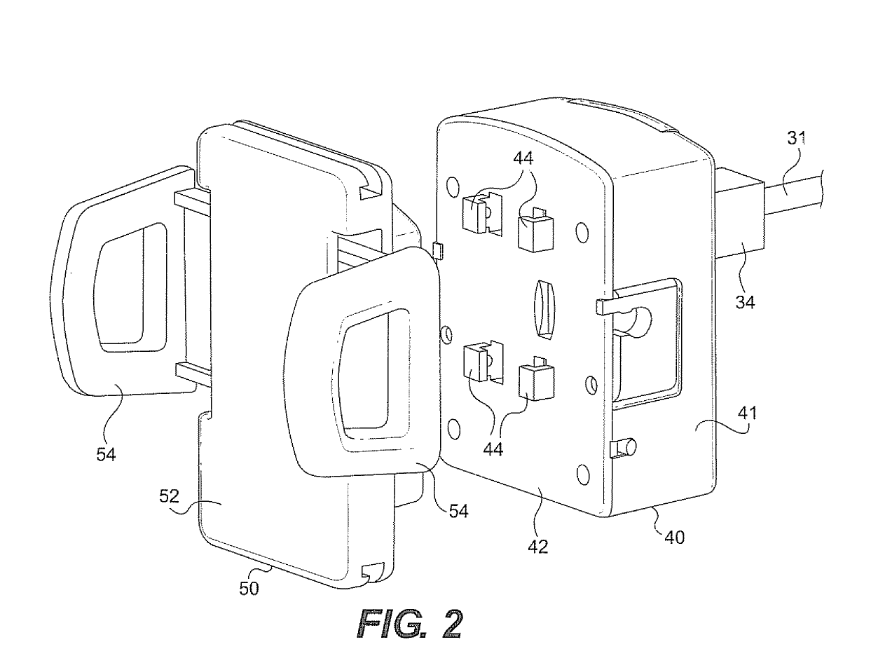

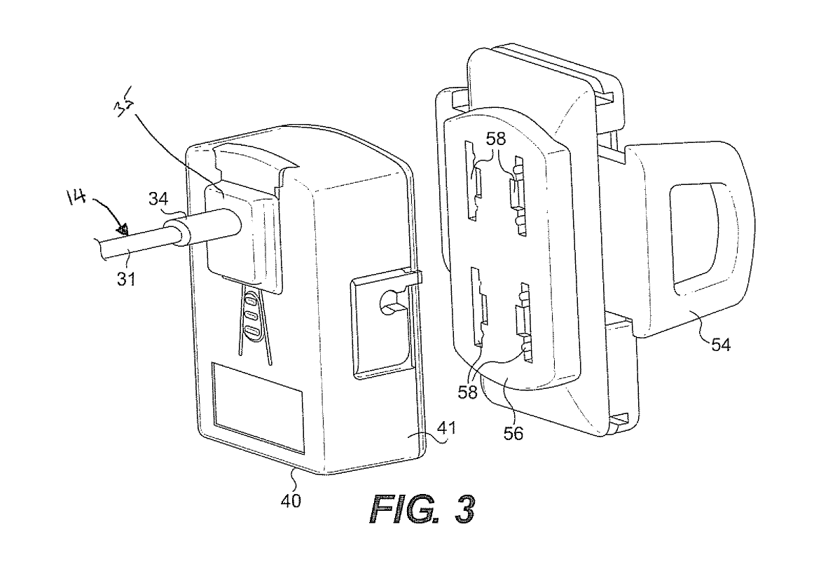

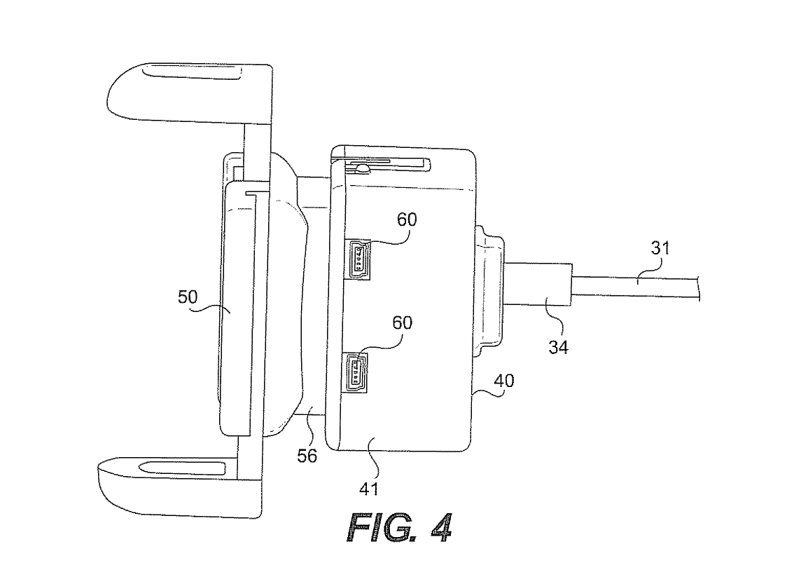

Referring now to FIGS. 1-4, there is shown an example of a mount system 10 that includes a male plug 12, a support arm 14, and a connector housing 16. The male plug 12 includes a round barrel 20 with a metal tip 22 and a side metal ring 24. The male plug 12 is insertable in the automobile electrical socket. The diameter of the male plug 12 is only slightly less than the diameter of the electrical socket in the automobile. The male plug 12 may optionally include springs to create a tight interference fit. Alternatively, the plug 12 may have a compression fitting that, once inserted, can be manually tightened to create a secure fit within the automobile electrical socket. A tight fit is important to achieve the mount purpose of the mount system.

The support arm 14 includes a rigid metal rod 30 that is secured on one end 32 to the plug 12 and on its opposite end 34 to the connector housing 16. In the illustrated example, there is a plastic corrugated sleeve 31 around the rigid metal rod 30. The sleeve 31 is loose but could be a tight fit around the rod 30 or even coated onto the rod. An interconnecting wire (not shown) is electrically connected to the plug and the connector housing. The wire is threaded inside the sleeve 31. The metal rod 30 may be bent to assume a shape or direction at the desire of a user. Preferably, the rod 30 is an aluminum rod, because it is a firm support but also able to be bent. Of course, other metals and/or multiple rods may be used. The support arm 14 can be any length, but typically it is 3-12 inches in length for most vehicles and uses.

The connector housing 40 comprises a rectangular box 41. Inside the box 41 is electrical circuitry that is collectively referred to herein as a transformer. The transformer converts the 12 volts of electrical power from a conventional automobile battery to an acceptable voltage and amperage for the electrical products to be mounted on the system. The transformer includes conventional circuitry to control and meter the correct amount of electrical flow. In the illustrated example, universal connector sockets 60 are shown having the USB configuration. Of course, the universal connector sockets 60 may have different formats or conventions. The electrical device that may be placed on the mount 50 will have a product-specific adaptor. Accordingly, it is possible to have product-specific adaptors that connect the universal connector sockets 60 (USB ports) to the specific product. The universal connector housing 40 further includes male connector prongs 44 that interchangeably receive a mount 50.

The mount 50 has a flat platform 52 and side wings 50 that may be squeezably pressed against and retain an electrical product on the mount. The back face 56 of the mount 50 has female recesses 58 that receive the male prongs 44 from the connector housing box 41. Alternatively, the mount 50 may comprise the male prongs and the connector housing box may have the female recesses.

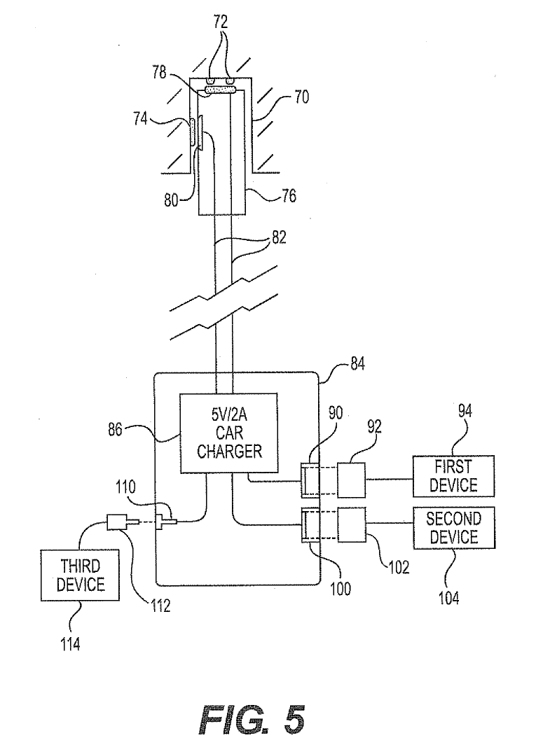

Referring to FIG. 5, there is shown a conventional automobile electrical socket 70. The socket 70 includes electrical contacts 72 and 74. The plug 76 includes corresponding contacts 78 and 80 that, when inserted in the socket 70, are in electrical communication with the contacts 72 and 74. An interconnecting wire 82 is the electrical connection between the plug 76 and the connector housing 84. Inside the connector housing 84 is a conventional car charger circuit 86. The car charger circuit 86 converts power from the automobile electronics system to generally universal voltage and current compatible with particular devices or classes of devices. In one example, the car charger circuit 86 is a 5 volt/2 amp type of circuit suitable for use with many electronics devices. The connector housing 84 includes universal electrical connector sockets 90, 100 and 110. The universal electrical connector sockets 90 and 100 are the same convention, in this example, USB sockets. Universal electrical connector socket 110 is an alternative format of socket. Device specific connectors 92, 102 and 112 may be plugged into the universal electrical connector sockets 90, 100 and 110 respectively. The device specific plugs 92, 102 and 112 connect to first device 94, second device 104, and third device 114 respectively. Additional power/charging circuitry may be configured in the connectors 92, 102 or 112 if necessary for the specific devices 94, 104 or 114. In this way, one or more electronic devices may be charging through use of the connector housing 84. Presumably, one or more of the devices 94, 104 and 114 is mounted on the mount that is a part of the connector housing 84.

Referring again to FIG. 3, the end 34 of the support arm 14 may include a bracket 35 that makes the support arm slidably removable from the rectangular box 41 of the connector housing. In an additional example, the support arm 14 is removed from the connector housing 40, and a wire cable (not shown) may be directly connected to the automobile electrical power system either through a plug like plug 12 or otherwise directly into the automobile wiring. The box 41 would then be permanently fixed in some manner to a surface inside the automobile. The benefits of multiple connector sockets 60 and an interchangeable mount system would still be available to a user in the automobile. The only difference is that the plug 12 and support arm 14 are not necessary.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

1. A powered, mobile electronics mount system comprising:
a male plug, a support arm, a connector housing, and an interconnecting wire;
the male plug comprising an electrical connector, wherein the plug is adapted to be inserted into an automobile electrical socket;
the support arm connected on one end to the male plug and on its opposite end to the connector housing;
the connector housing comprising a transformer and a plurality of universal electrical connector socket, and the connector housing further comprising a mount for an electronics product;
the interconnecting wire being in electrical connection with the automobile electrical socket through the plug and the universal electrical connector in the connector housing.

2. (canceled)

3. The mount described in claim 1, wherein the voltage input at the automobile electrical socket is 12 volts.

4. The mount described in claim 1, wherein the voltage output at the universal electrical connector socket is 5 volts.

5. The mount described in claim 1, wherein the universal electrical connector socket is a USB connector socket.

6. The mount described in claim 1, wherein the plurality of universal electrical connector sockets are different connection sockets.

7. The mount described in claim 1, wherein the mount on the connector housing is selectively removable from the connector housing.

8. The mount described in claim 7, wherein the connector housing comprises male mating elements adapted to receive a plurality of different, interchangeable mounts.

9. The mount described in claim 1, wherein the support arm is flexible whereby it is adapted to be selectively bent to a desired orientation by a user.

10. The mount described in claim 1, wherein the support arm has a sleeve and the interconnecting wire is positioned inside the sleeve.
